(19) United States
(12) Patent Application Publication
(10) Pub. No.: US 2012/0150739 A1
(43) Pub. Date: Jun. 14, 2012

(54) SYSTEM AND METHOD FOR AUTOMATIC PAYMENT OF FINANCIAL OBLIGATIONS

(75) Inventors: Gary E. Abeles, Verona, NJ (US); Joseph Pannullo, Kearny, NJ (US)

(73) Assignee: INTELLECTUAL TAX PROPERTIES, INC., Kearny, NJ (US)

(21) Appl. No.: 13/399,262

(22) Filed: Feb. 17, 2012

Related U.S. Application Data
(63) Continuation-in-part of application No. 13/230,881, filed on Sep. 13, 2011, now Pat. No. 8,135,634.
Application No. 13/230,881 is a division of application No. 11/623,083, filed on Jan. 14, 2007, now Pat. No. 8,036,959.
Application No. 11/623,083 is a continuation-in-part of application No. 13/344,951, filed on Jan. 6, 2012.
Application No. 13/344,951 is a continuation-in-part of application No. 13/031,837, filed on Feb. 22, 2011, now Pat. No. 8,117,098.
Application No. 13/031,837 is a continuation of application No. 12/576,595, filed on Oct. 9, 2009, now Pat. No. 7,912,768.
Application No. 12/576,595 is a continuation-in-part of application No. 11/623,083, filed on Jan. 14, 2007, now Pat. No. 8,036,959.
(60) Provisional application No. 60/862,474, filed on Oct. 23, 2006.
(60) Provisional application No. 60/862,474, filed on Oct. 23, 2006.
(60) Provisional application No. 61/103,949, filed on Oct. 9, 2008.

(51) Int. Cl. G06Q 20/40

(52) U.S. Cl. 705/40

(57) ABSTRACT

A method for reserving funds to pay an estimated tax or other financial obligation includes receiving by a service provider of financial information from a customer and transferring funds from a customer monetary source to a set-aside account, where the monetary source and/or the set-aside account is a stored value account. In embodiments, the customer can access the set-aside money if needed before it is used to pay the obligation. The set-aside account can be a stored value card provided to the customer and usable in lieu of a bank card. Stored value cards can be visibly distinct according to which of a plurality of obligations they apply. Or the set-aside account can be a stored value account maintained by the service provider as information in a database. Set-aside funds can be transferred automatically and/or electronically, or provided by the customer as cash or cash equivalents.

### RELATED APPLICATIONS

This application is a continuation in part of U.S. application Ser. No. 13/230,881, filed on Sep. 13, 2011, which is a divisional of U.S. application Ser. No. 11/623,083, filed on Jan. 14, 2007 (U.S. Pat. No. 8,036,959, issue date Oct. 11, 2011), which claims the benefit of U.S. Provisional Application No. 60/862,474, filed Oct. 23, 2006. This application is also a continuation in part of U.S. application Ser. No. 13/344,951, filed on Jan. 6, 2012, which is a continuation in part of U.S. application Ser. No. 13/031,837, filed Feb. 22, 2011, which is a continuation of U.S. application Ser. No. 12/576,595, filed Oct. 9, 2009 (U.S. Pat. No. 7,912,768, issue date Mar. 22, 2011), which is a continuation-in-part of U.S. application Ser. No. 11/623,083, filed Jan. 14, 2007 (U.S. Pat. No. 8,036,959, issue date Oct. 11, 2011), which claims the benefit of U.S. Provisional Application No. 60/862,474, filed Oct. 23, 2006. U.S. application Ser. No. 12/576,595 also claims the benefit of U.S. Provisional Application No. 61/103,949, filed Oct. 9, 2008. Each of these applications is herein incorporated by reference in its entirety for all purposes.

### FIELD OF THE INVENTION

The invention relates to methods for financial management, and more particularly, to methods for managing revenue in preparation for payment of a financial obligation.

### BACKGROUND OF THE INVENTION

At present, tax authorities, such as the Internal Revenue Service (IRS) provide paper vouchers to tax payers for estimating taxes, and the tax payers or their accountants must manually maintain the payment stream to the taxing authorities. Internal Revenue Bulletin #IR-2006-28 dated Feb. 14, 2006 indicates that third-party involvement in reporting or withholding tax payments increases the compliance of tax payment practices. For example, taxes reported under Schedule C, subject to relatively less typical 3rd party-reporting or withholding, has a net misreporting of 57% of wage information, while taxes reported under W-2, subject to typical 3rd party-reporting or withholding has a net misreporting of 1% of wage information. Information misreported under Schedule C contributes to a $68 billion dollar annual payment deficit to the IRS.

One approach for a self-employed individual is to divide the estimated annual tax liability into smaller amounts that can be set aside monthly, weekly, or according to whatever set-aside period the individual prefers. For example, the individual can establish a separate set-aside bank account for accumulating estimated taxes, and can arrange for his or her bank to automatically transfer a fixed amount from a checking account into the set-aside account every week, every month, or according to whatever set-aside period the individual chooses. Estimated taxes can then be paid from the set-aside account as they come due.

This set-aside practice has been recommended to clients by more than 70% of accountants surveyed, yet it is almost never followed, due to many drawbacks and complications. In the US, estimated tax payments are due on April 15^{th}, June 15^{th}, September 15^{th}, and January 15^{th}. These due-dates divide the tax year into estimated tax intervals which vary in length from 8 weeks to 18 weeks, or from two months to four months. Therefore, simply dividing the annual tax liability into equal, smaller amounts to be set aside every week or every month will result in shortfalls and penalties in two quarters. The set-aside amount can be manually recalculated and adjusted for each estimated tax interval, but this can be burdensome to the tax payer, and will result in significant fluctuations from interval to interval in the amounts transferred to the set-aside account.

In addition, self-employed individuals frequently receive their incomes at unequal and even unpredictable rates, and the total amount of income for a self-employed individual's tax year may be difficult to predict. This can lead to frequent adjustment of the estimated tax liability, and frequent re-calculation of the set-aside amounts, as income fluctuates during the course of a tax year. And even if self-employment income is somewhat steady and predictable, adjustments may be required after calculation and payment in April of the previous year's taxes.

Cash shortfalls may also necessitate adjusting or missing some periodic set-asides, or even underpaying or missing an estimated tax payment, and may therefore require re-calculation and adjustment of the set-aside amounts. Beginning the set-aside process after a tax year has begun can further complicate the scheduling of appropriate set-asides, and may require adjustment of the set-aside amounts so as to compensate for estimated tax payments that have already been missed and/or overpayments that have already been made.

For the reasons given above, a large number of self-employed individuals and business owners (many of whom lack sufficient regimentation and discipline) have found it too difficult and too burdensome to calculate and set-aside appropriate amounts of estimated tax revenue on a frequent, regular basis, despite the clear and significant benefits that would be realized therefrom.

While the preceding discussion is focused on estimated tax payments, and on setting aside smaller amounts in multiple periods, other circumstances can give rise to similar revenue set-aside best practices, needs, and difficulties. For example, when income is unpredictable, it can be difficult to calculate appropriate set-aside amounts for payment of child support, alimony, church contribution commitments, retirement savings, home mortgages, savings accounts, emergency funds, and such like. In other examples, the financial obligation itself may vary, depending on the amount and timing of current income rather than a prior year income or tax, or on some other current variable such as sales, or even a non-financial variable such as incremental usage of a resource, resulting in a varying obligation that affects an optimal schedule of payments. In some circumstances, such as church “tithing” contributions, the total amount to be paid can depend on a payer's income, requiring that set-aside amounts be adjusted according to changes in actual and/or predicted income.

The setting of funds aside can become even more burdensome for an individual if it is desirable to accrue funds simultaneously for a plurality of obligations, thereby requiring the individual to create and manage a plurality of separate bank accounts under his or her direct control. The individual may also fear that his or her credit report may suffer from the appearance of so many accounts. Or, a user may not even have a bank account, and may not be eligible or may not wish to open a bank account.

Situations can also arise where it may be desirable to set aside funds in a single set-aside transaction. For example, an individual may receive a significant bonus or commission payment once per month or once per quarter, and may wish to set aside funds in a single transaction that are sufficient to meet an anticipated expense such as a monthly rent or quarterly estimated tax payment. Or an individual may wish to set aside funds out of each weekly paycheck in anticipation of different expenses, for example setting aside funds from the first week for monthly groceries, from the second week for alimony, from the third week for rent, and so forth. Although the entire amount for each expense may be available all at once, it may nevertheless be preferable to set the funds aside until payment is due. It may be difficult or impossible to make an early payment of an obligation. For example, groceries must be purchased as they are needed. Also, early payment of an obligation forecloses the option of using the funds to meet unexpected emergencies or take advantage of unexpected opportunities that might arise.

One approach is for a third party service provider to establish and manage the set-aside accounts, and thereby relieve the individual customer from the requirement to open and manage set-aside accounts. However, due to concerns about unexpected needs for cash, for example due to an unexpected personal or self-employment expense or investment opportunity, the individual may be reluctant to accrue funds in accounts over which he or she does not have direct control, and from which he or she cannot instantly retrieve funds if needed.

A need therefore exists for a method to facilitate setting aside of funds in preparation for payment of one or more financial obligations whereby the user maintains direct control over and immediate access to the funds until they are disbursed, but the user is not burdened with a necessity of establishing and managing one or more separate fund accrual bank accounts. A further need exists for such a method to set aside funds according to a schedule that is flexible and adaptable to individual preferences, and that is responsive to both anticipated and unanticipated fluctuations in obligation requirements and client funding during the accrual period.

### SUMMARY OF THE INVENTION

The present invention is a financial management method and system that can be practiced by a third party service provider to facilitate an accrual of funds in anticipation of a customer meeting one or more financial obligations, such as estimated tax payments due to a taxing authority. The method includes accepting financial information from the customer regarding an amount due for each financial obligation and a date by which the payment of each financial obligation is required, and determining a schedule according to which amounts of money should be set aside from a financial source applicable to the customer. In various embodiments, the required amount can be set aside all at once, or a plurality of smaller amounts can be set aside, where each amount periodically set aside is less than the estimated tax or other payment due, and the combined value of the amounts set aside by the payment due date substantially matches or exceeds the estimated tax payment or other payment due.

According to the present invention, one or more stored value accounts are used either as the monetary source and/or as the account or accounts in which the set-aside amounts are held until disbursement. Using one or more stored value accounts as the monetary source allows a customer to use the method even if the customer does not have a bank or brokerage account. Using one or more stored value accounts to hold the funds until disbursement provides to the user direct and immediate control over the funds until they are disbursed, without a requirement for the customer to establish and maintain a bank account or accounts for the fund accruals.

In certain embodiments, the financial source is cash or cash equivalents, such as bank checks provided by the customer to the third party service provider according to the set-aside schedule. These embodiments are especially suitable for customers who do not have or do not wish to use a bank account or a brokerage account as a monetary source.

In some embodiments, the stored value accounts are stored value cards that store the accrued funds on the cards themselves, by means of a magnetic stripe, RFID chip, or similar mechanism. A card is provided to the customer for each amount set aside, and in embodiments the cards are visually distinguishable from each other according to the corresponding financial obligations to which they are directed. For example, blue cards may be set-aside for payment of estimated federal taxes, red cards for estimated state taxes, green for rent payments, and so forth. In these embodiments, the customer maintains physical possession of the cards, and then uses them when needed to pay each obligation. In some of these embodiments, the customer can use the stored value cards in lieu of credit cards for the payment of the financial obligations. And if an unanticipated need for funds should arise before disbursement, in embodiments the customer can use one or more of the stored value cards to pay the unanticipated expenses, or the customer can use the cards at a bank or an ATM to obtain cash or to transfer funds to a bank account.

In other embodiments, the set-aside funds are held in one or more stored value accounts that are maintained as data in a database that is accessible by telephone and/or over the internet using an account number or name and a PIN number, password, or other identifying code. In some of these embodiments, the database is updated each time funds are set aside. In various of these embodiments, the customer can access each stored value account by telephone or online, and can directly transfer money into a bank account or withdraw funds in cash if such a need should arise before the funds are disbursed.

In various embodiments, funds are transferred to and from the one or more stored value accounts by exchange of cash or cash equivalents, by electronic transfer to and from bank accounts, by using a “peer-to-peer” or “P2P” funds transfer network, and/or by other methods of monetary transfer known in the art.

In embodiments, the set-aside funds are disbursed automatically in payment of the financial obligations when payments are due. In other embodiments, the customer is asked for approval before funds are disbursed.

In certain embodiments, the financial source is an employer or other income source for the customer. For example, funds may be directly set aside from a customer's wages in anticipation of meeting rent or child support obligations, or even as a method of budgeting for the eventual purchase of necessities such as groceries using one or more stored value cards in lieu of a credit card. Such embodiments may be applicable, for example, to a customer who does not have a bank account.

Various embodiments further include adjusting an amount of funds set aside and or adjusting a timing of a setting aside of funds according to an amount of funds available to the customer. Some of these embodiments include monitoring a balance of funds in the monetary source from which the amounts of money are set aside.

Some embodiments further include determining and updating the amount of one or more financial obligations according to income and other financial data obtained initially and/or during the accrual period.

In various embodiments where funds are set aside in anticipation of meeting a plurality of financial obligations, the financial obligations are prioritized, so that amounts and/or timing of funds set aside for a lower priority obligation are adjusted so as to avoid depleting funds available to set aside for a higher priority financial obligation.

Certain embodiments further include borrowing money so as to provide funds to set aside.

In various embodiments funds are set aside approximately one of hourly, daily, weekly, monthly, quarterly, and annually.

The present invention is a financial management method executed by a third party service provider for reserving funds in anticipation of meeting a financial obligation of a customer without reducing, avoiding, or deferring any portion of the financial obligation, the financial obligation including a payment amount due to a creditor by a payment due date. The method includes receiving financial data corresponding to the customer, the financial data including data regarding the financial obligation; during a set-aside period leading up to the payment due date, transferring one or more amounts of money from a monetary source corresponding to the customer to a set-aside account, where the sum of the transferred amounts of money is equal to or more than the payment amount, at least one of the monetary source and the set-aside account being a stored value account; and in a single transaction prior to or on the payment due date, using the money in the set-aside account to meet the financial obligation without reducing, avoiding, or deferring any portion of the financial obligation.

In embodiments, the customer is able to withdraw money from the set-aside account before the money is used to meet the financial obligation.

In certain embodiments, the customer is able to adjust at least one of an amount of money transferred and a timing of a transfer of money during the set-aside period.

In various embodiments, the set-aside account is a stored value card, and the method further includes providing the stored value card to the customer. In some of these embodiments, the stored value card can be used by the customer in lieu of a bank card. In other of these embodiments, amounts of money are transferred from at least one monetary source to a plurality of stored value cards in anticipation of meeting a plurality of financial obligations, and each of the stored value cards includes a visibly perceptible indication that identifies to which of the financial obligations it is directed.

In some embodiments, the set-aside account is a stored value account maintained by a data processing system as information in a database. In some of these embodiments the money transferred to the stored value account is automatically disbursed by the third party service provider to meet the financial obligation. And in some of these embodiments the money is disbursed electronically.

Various embodiments further include monitoring during the set-aside period an amount of funds available from the monetary source, and determining at least one of when to transfer money to the set-aside account and how much money to transfer to the set-aside account according to the amount of funds available from the monetary source.

In some embodiments, the creditor is a taxing authority. In some of these embodiments, the financial obligation is an estimated tax payment. And some of these embodiments further include determining the estimated tax due as a function of the received financial data.

In certain embodiments the financial obligation is a mortgage payment. In some embodiments the monetary source is at least one of a bank account, a stock portfolio account, and a trust fund.

In various embodiments the monetary source is cash or a cash equivalent provided by the customer to the third party service provider 17. The method of claim 1, wherein the financial source is a source of wages for the customer.

Some embodiments further include borrowing money so as to provide funds for transfer to the set-aside account.

In certain embodiments, one or more amounts of money are transferred to the set-aside account periodically according to a set-aside schedule. Some of these embodiments further include accepting from the customer set-aside preferences including a preferred set-aside period and an amount per period to be set aside, and determining the set-aside schedule according to the set-aside preferences. And other of these embodiments further include displaying to the customer the set-aside schedule, and enabling the customer to accept or adjust the set-aside schedule.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention will be understood and appreciated more fully from the following detailed description taken in conjunction with the drawings in which:

FIG. 1 depicts a local and remote system, according to one embodiment of the present invention;

FIG. 2 depicts a web page produced by an embodiment of the present invention, and its interaction with various components of one embodiment of the present invention;

FIG. 3 is a flow diagram of a method according to an embodiment of the present invention that includes stored value cards;

FIG. 4 is a flow diagram of a method according to an embodiment of the present invention that includes stored value account information stored in a database; and

FIG. 5 is a flow diagram of a method according to an embodiment of the present invention in which the financial source is a stored value account.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. For example, the invention is frequently described in terms of managing finances in anticipation of payment of an estimated tax obligation to a taxing authority. However, it will be clear to one skilled in the art that the present invention can be applied to the satisfaction of any financial obligation. It will also be apparent that embodiments of the invention described herein in terms of payment of a single financial obligation are intended also to extend wherever applicable to payment of a plurality of financial obligations, and that embodiments described herein in terms of payment of a plurality of financial obligations are intended also to extend wherever applicable to satisfaction of a single financial obligation.

Furthermore, well-known features may be omitted or simplified herein in order not to obscure the present invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appears from the description herein. In addition, embodiments of the present invention are not described with reference to any particular programming language. It will be appreciated that a variety of programming languages may be used to implement the teachings of the invention as described herein.

Unless specifically stated otherwise, as apparent from the discussions herein, it is appreciated that throughout the specification discussions utilizing data processing or manipulation terms such as “processing”, “computing”, “calculating”, “determining”, or the like, typically refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments described in each of U.S. Pat. No. 6,898,573 B1 to Piehl et al, issued May 24, 2005, US Publication No. 2002/0198832 A1 to Agee et al., published Dec. 26, 2002, US Publication No. 2002/0178039 A1 to Kennedy, published Nov. 28, 2002, Internal Revenue Service form 1040-ES payment voucher, State of New Jersey form NJ-1040-ES NJ gross income tax forms, the First Farmers and Merchants Bank Christmas Club Plan, the Columbia Gas of Pennsylvania and Columbia Gas of Maryland Automated Debit Payment Program, Paypal payment plans and options, and the directpaymentplaning.com website, may be used in accordance with the present invention, and are all incorporated herein by reference in their entirely.

Embodiments of the present invention enable the customer to set-aside funds in anticipation of meeting one or more financial obligations. According to the embodiment, at least one stored value account is used as a funding source and/or as an account in which funds are set aside. In various embodiments, funds are transferred to and from the one or more stored value accounts by exchange of cash or cash equivalents, by electronic transfer to and from bank accounts, by using a “peer-to-peer” or “P2P” funds transfer network, and/or by other methods of monetary transfer known in the art.

In various embodiments, the entire amount required for meeting an obligation can be set aside all at once. For example, an individual may receive a significant bonus or commission payment once per month or once per quarter, and may set aside funds in a single transaction that are sufficient to meet an anticipated expense such as a monthly rent or quarterly estimated tax payment. Or an individual may set aside funds out of each weekly paycheck in anticipation of different expenses, for example by setting aside funds from the first week's paycheck for monthly groceries, from the second week's paycheck for alimony, from the third week's paycheck for rent, and so forth.

In other embodiments, a plurality of smaller amounts are set aside that collectively amount to an estimated tax due to a taxing authority or to an amount due for meeting another financial obligation. For example, the customer may set aside monies on a weekly basis for payment of income taxes and social security taxes, or for paying child support or rent. Embodiments of the present invention may be suitable for customers that are sole proprietors, single member limited liability companies, partners in a partnership, or individuals managing their personal finances. It should be noted that the term “customer” is used herein to refer to any tax paying entity that has to pay estimated taxes and plan for such payments in the course of its operations, and any other individual or entity that is required to meet a financial obligation.

In some embodiments of the present invention the financial source from which funds are set aside is cash, checks, or other cash equivalents provided by the customer to the third party service provider according to the determined set-aside schedule. In other embodiments an automated method and system is provided for setting aside monies from a monetary source associated with the customer, such as a customer's bank account or salary, in anticipation of meeting a financial obligation, such as an estimated tax for the customer, and accumulating sufficient funds to meet the tax payments or other financial obligations. The estimated tax or other obligation may include a predicted amount of money due and a time and/or date by which the payment is due.

The amount of the financial obligation may be calculated, for example, according to a formula based on personal and/or financial information input by the customer, or input by a financial professional on behalf of the customer. Personal and/or financial information may include, for example, a filing status requiring the use of form W-2 or schedule C of form 1040, an annual or quarterly income, a number of dependents, etc. Funds can be set aside in preparation for payment of a plurality of financial obligations. An amount of at least one financial obligation and a schedule for setting funds aside can be adjusted during an accrual period according to financial information received during the accrual period.

Monies can be set aside from the monetary source selected by the customer, for example, a personal or business bank account, a stored value account, or some other account under the control of the customer, from the customer's employer, from cash or from a stored value account. The customer can authorize an automated payment mechanism to set money aside, for example, by providing an access code to the customer's bank account using a secure channel, for example, over the Internet. The customer may use a “peer-to-peer” or “P2P” funds transfer network. Or the customer may make other arrangements as appropriate, such as arranging with an employer for a certain portion of the customer's wages to be diverted for setting aside, or by using cash or a stored value card to make payments in person at a facility provided by the service provider. The customer may provide monies, for example, according to a predefined contract or agreement.

Funds that are set aside are maintained in one or more bank accounts or one or more stored value accounts until disbursed in fulfillment of the one or more financial obligations. In some embodiments, the funds are transferred to stored value cards, which are maintained by the customer and used for payment of the financial obligations. In other embodiments, the funds are transferred to a stored value account that is maintained in a database.

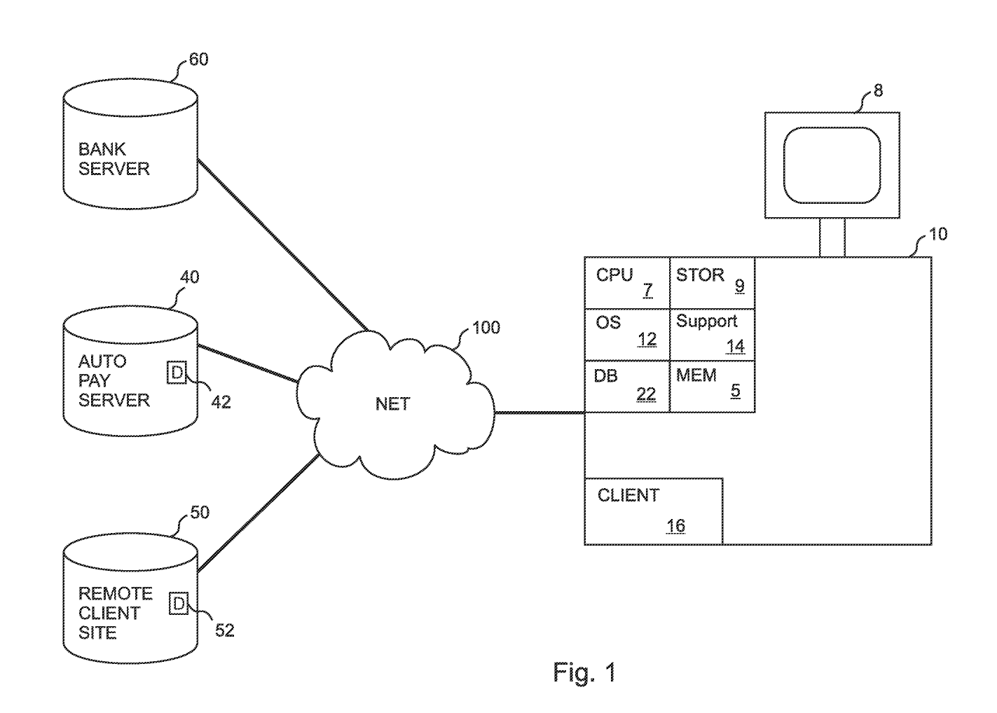

With reference to FIG. 1, embodiments of the present invention may include a computer or computing system 10 to maintain the bank accounts and/or stored value accounts, automatically track and/or record estimated tax payments or other disbursements for the customer, and automatically deduct from the bank accounts and/or stored value accounts amounts necessary to meet taxing authority payment requirements and/or other financial obligations. Practitioners of ordinary skill will recognize that a stored value account in a computer system is a set of data stored in the system that is related to the customer or account owner or the taxing authority, including data representing the amount of money held in the account or for the benefit of the customer or taxing authority or other account owner. Storage of the data is typically by means of well-known mass storage devices 9, including disk drives, optical drives or other data storage technologies, and is typically stored in a database of a type well known in the art.

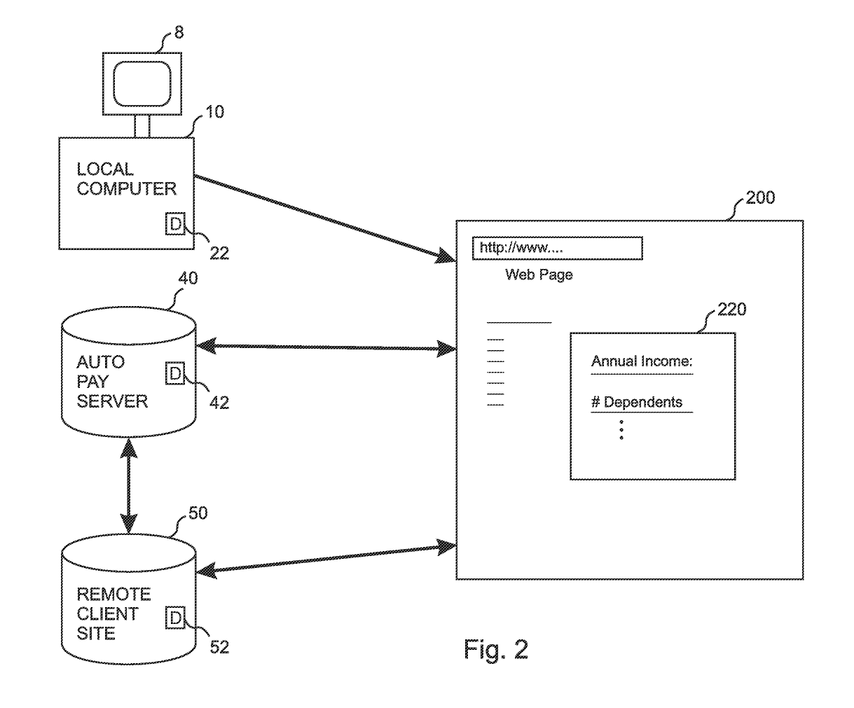

FIG. 1 depicts a local and remote system, according to an embodiment of the present invention wherein set-aside funds are held in one or more stored value accounts. Local computer 10 may include a memory 5, processor 7, monitor or output device 8, and mass storage device 9. Local computer 10 may include an operating system 12 and supporting software 14 (e.g., a web browser or other suitable local interpreter or software), and may operate a local client process or software 16 (e.g., JavaScript or other suitable code operated by the supporting software 14) to produce an interactive display such as a web page for providing a customer with a graphical user interface, such as graphical user interface 220, described in further detail below in reference to FIG. 2.

In embodiments of the invention, local computer 10 may accept customer input, maintain customer stored value accounts, automatically track and/or record estimated tax payment requirements and other financial obligation requirements for the customer, establish security measures, for example, verifying customer identity, and automatically deducting from customer stored value accounts amounts necessary to meet a tax authority payment requirement or another financial obligation.

An automated payment server 40 may be used for making estimated tax payments on behalf of one or more customers, and a bank server 60, selected by the customer, may be a source from which monies are periodically set aside for transfer to stored value cards or stored value accounts in anticipation of making the estimated tax payments and/or meeting other financial obligations. Automated payment server 40 may store, for example, in database 42, estimated tax payment requirements for the customer, security information and stored value account information, and set-aside information may be transmitted to bank server 60 for executing fund transfers to the stored value accounts. In various embodiments, automated payment server 40 and bank server 60 may be operated by the same or different sources, for example, an automated payment service or bank service, respectively.

In some embodiments, either local computer 10 or automated payment server 40 may record a history of payments made on behalf of each customer. Local computer 10 or automated payment server 40 may include a database 42, for example, for recording customer stored value account details and histories. In some embodiments, customers may have access to the transaction history of their stored value accounts, for example, using a website. In some embodiments, the customer may have control of and may adjust the amount or schedule of the automatic or periodic payments, may block or overwrite such payments, and/or may withdraw funds from the one or more stored value accounts if an unanticipated need should arise.

In some embodiments, automated payment server 40 or local computer 10 may transmit a signal or message to bank server 60, for example, periodically to transfer an amount of money from an account held by the customer for setting aside in a stored value account. Messages may include data packets and may be transmitted and/or received between customer's computers, local computer 10, automated payment servers 40, bank servers 60, credit card machines, ATMs, and/or other payment devices. According to embodiments of the present invention, bank server 60 may periodically transfer an amount of money from an account held by the customer for setting aside in a stored value account, where each amount transferred is less than the estimated tax or other financial obligation, and the combined value of the amounts set aside by the due date substantially match or exceed the estimated tax or other financial obligation.

Bank server 60 may automatically transfer funds from the customer monetary source periodically, for example, hourly, daily, weekly, monthly, quarterly or annually. In similar embodiments, funds are transferred to and from the one or more stored value accounts by exchange of cash or cash equivalents, by electronic transfer to and from bank accounts, by using a “peer-to-peer” or “P2P” funds transfer network, and/or by other methods of monetary transfer known in the art.

In an exemplary embodiment, funds may be automatically transferred at a frequency, for example, on a weekly basis, to minimize the amount of monies set aside at one time. Once sufficient funds are accumulated in a stored value account, and a payment is due to a taxing authority, the payment can be made from the stored value account, either by the auto pay server 40 or by the client using stored value cards.

In other embodiments, funds are automatically set aside when sufficient funds have accumulated in the customer's monetary source, for example, when a monthly earning is received. In yet other embodiments, funds are only set aside upon approval by the customer. The monies that are set aside may be submitted to the appropriate taxing authority by the customer or automatically by a third party on behalf of the customer at a time determined according to the tax status of the customer. For example, taxes can be paid directly on a quarterly basis or at other times.

In some embodiments, local computer 10 and/or automated payment server 40 manages tax payments while taking into account other payments, such as monthly bills, mortgages, or other expenses. Based on financial information, for example, provided by a customer, a fixed, variable, or estimated amount of monies is reserved for various predicted expenses other than tax payments. For example, in some embodiments monies are automatically set aside from a customer's bank account when the monies in the account, excluding monies allocated to other payments or expenses, are determined to be sufficient.

In some embodiments, funds are set aside from various sources. For example, a monetary source may include a bank account, a stock portfolio, a trust fund, a customer's employer, cash or cash equivalents, a stored value account, and such like. For example, if monies are set aside from stocks, the setting aside may include automatically selling a certain value of stocks. Alternatively, funds might automatically be borrowed from a bank and held in a stored value account, with the stock portfolio as collateral. The customer and/or system may use preferential planning to select the optimal stocks to sell to acquire the necessary monies for setting funds aside. For example, if tax payments are deducted from multiple customer accounts operated by multiple banks, multiple bank servers 60 may be used, for example, each bank server 60 maintaining accounts for respective banks.

Setting monies aside may include for example, deducting, transferring, or moving monies from a customer's monetary source to another location. In one exemplary embodiment, the monies may be transferred to a single third-party tax payment account into which all such customer set-asides are transferred, with the individual set-aside amounts being credited to corresponding stored value accounts.

By the date payment of the tax or other financial obligation is due, sufficient funds for the payment should have been accumulated in the stored value account by the periodic set-aside mechanism. At this point the local computer 10 or automated payment server 40 can calculate an amount to deduct from the customer's bank account or stored value account and can transmit a payment via the net 100 to the taxing authority, for example using the EFPTS system, based on the estimated tax calculated. Payment instructions, based on the estimated tax, may include authorization for processing a tax payment or transfer of funds, the amount to be paid and the source and destination for the transfer of funds. Payment server 40 may execute a payment, according to the payment instructions. In some embodiments, payments to the taxing authority may include submitting a customer's personal and/or financial information, including for example social security number associated with the user, the amount to be paid, and appropriate instructions and security data.

Automated payment server 40 and/or local computer 10 may include security and utility codes and may generate security or verification information. Such verification information may be used to allow the appropriate customer to monitor and/or control their stored value accounts for payment of taxes and/or for satisfying other financial obligations. Such verification information may also be used for metering or billing customers for use of services. In embodiments, security or verification information includes both the identity of the client process and a domain name. The pairing of the domain name and the client identity may serve as an authentication key. Security or verification information may correspond to or identify the local client in other manners. In some embodiments, automated payment server 40 or local computer 10 may analyze customer input and/or authentication information received to generate authentication or security conditions or information.

In some embodiments, the customer is given a device that accepts and verifies a customer PIN number or password, and then generates a validation code that is dependent on the current date and time, so that each generated validation code is only valid for a short time, such as a few minutes. In these embodiments, the customer's identifying information is not vulnerable to key-logging or other methods of password interception, nor can the validation-generating device itself be used by others who do not possess the required password or PIN number.

FIG. 2 depicts a web page 200 produced by an embodiment of the present invention, and its interaction with various components of one embodiment of the present invention. The web page 200 may include a graphical user interface 220 that can accept an input from a customer such as personal and/or financial information and access to the customer's monetary source.

Customer input can be stored in the local computer 10 or in the automated payment server 40 or remote client site 50, for example, in databases 22, 42, and 52, respectively. The local computer 10 or automated payment server 40 may receive customer input via remote client site 50 or directly from web page 200, via a network or the internet 100. Customer input may be information specific to a customer, such as the identity of the customer, a filing status requiring the use of form W-2 or schedule C of form 1040, an annual or quarterly income, a number of dependents, an amount of estimated tax payment for the year, the location and access information to a monetary source of funds to pay taxes. In one embodiment, the customer may provide information required in standard tax forms.

In some embodiments, customers are required to register or enter preliminary information to enlist payment services according to embodiments of the invention. For example, customers may be required to provide personal and/or financial information using graphical user interface 220. Required information may include the customer's name, address, social security number, monetary source information, amount, schedule, and/or restrictions for setting monies aside, email address, telephone and fax numbers, etc. Each customer may provide identification information, such as a pin number, which may be required to access the system.

It will be appreciated by those of ordinary skill in the art that the third party service provider managing the set-aside payments and stored value accounts can be a professional accountant or other service provider. Various embodiments of the invention can provide that the service provider have authenticated access to the customer's monetary source accounts and/or that the customer provide to the third party service provider the information that determines the estimated tax amount and/or amount(s) of other financial obligation(s). The service provider can then issue stored value cards and /or access, modify, or set up one or more stored value accounts on the third party's servers in which the funds set aside from the customer's monetary source or sources are stored. In this way, the service provider determines how much to set aside and collects and stores the set-aside monies. The third party service provider then, through messages between the third party servers and the IRS servers, makes the tax payment that is due or otherwise satisfies the financial obligation.

Although the customer interface has been described above as being a webpage presented on a customer's computer, other output modules are used in embodiments of the present invention. For example, an ATM, telephone, facsimile, or other device-based service may enable customer input and provide automated payment services as described herein. In embodiments, a customer can also provide information and monitor and access funds by visiting in person a facility provided by the service provider.

Although embodiments of the present invention have been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiments described herein are intended only to provide examples and are not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

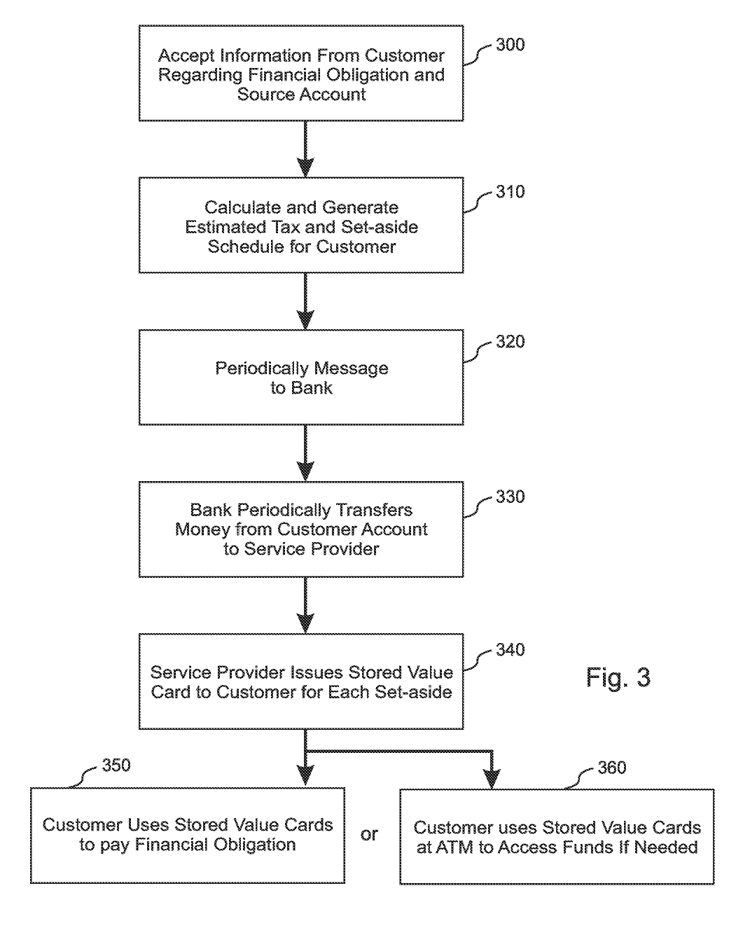

FIG. 3 is a flow diagram that illustrates a method according to an embodiment of the present invention in which funds that are set aside are transferred to stored value cards that are held by the customer until disbursement for payment of a single financial obligation.

In operation 300, a third party service provider accepts financial information from a customer regarding a financial obligation and a monetary source. For example, a web page is displayed on the customer's computer and the customer enters financial information into a graphical user interface provided by the web page.

In operation 310, an estimated amount of the tax or other financial obligation is calculated, and a schedule for setting funds aside is determined.

In operation 320, periodic fund transfer messages are sent to the bank or other host of the source account identified by the customer. Accordingly, in operation 330, the bank or other host sets the requested funds aside from the monetary source account and sends the funds to the third party service provider.

In operation 340, the third party service provider issues a stored value card to the customer for each amount set aside. In operation 350, if all goes as planned the customer then uses the stored value cards to satisfy the financial obligation. However, in operation 360 if an unexpected need should arise, the customer can use the stored value cards to meet the unexpected need, or to obtain cash e.g. at an ATM as needed.

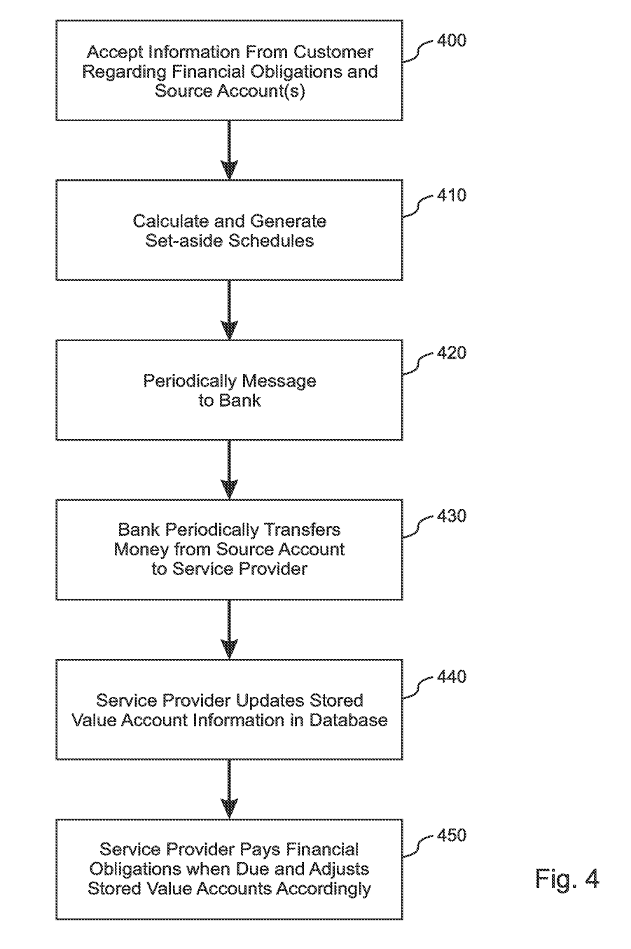

FIG. 4 is a flowchart of a method according to an embodiment of the present invention in which the funds that are set aside are maintained by a third party service provider in a plurality of stored value accounts recorded in a database.

In operation 400, a third party service provider accepts financial information from a customer regarding a plurality of financial obligations and at least one monetary source. For example, a web page is displayed on the customer's computer and the customer enters financial information into a graphical user interface provided by the web page.

In operation 410, estimated amounts and set-aside schedules are determined for each of the financial obligations.

In operation 420, periodic fund transfer messages are sent to the bank or other host or hosts of the source account or accounts identified by the customer.

Accordingly, in operation 430, the bank or other host or hosts sets aside the requested funds from the monetary source account or accounts and sends the funds to the third party service provider. In similar embodiments, set-aside funds are provided by the customer in person by providing cash or cash equivalents to the service provider, or by using a stored value card and/or some other form of stored value account to provide funds to the service provider.

In operation 440, the third party service provider updates stored value account information in its database according to the set-aside funds that are received.

And in operation 450, the third party service provider pays each of the financial obligations when due and adjusts the stored value account information accordingly. In embodiments, if an unanticipated need arises, the customer can access the stored value accounts through a website provided by the third party service provider or by directly contacting the third party service provider, and the customer can direct that funds be restored to the monetary source or otherwise used to meet the unanticipated need.

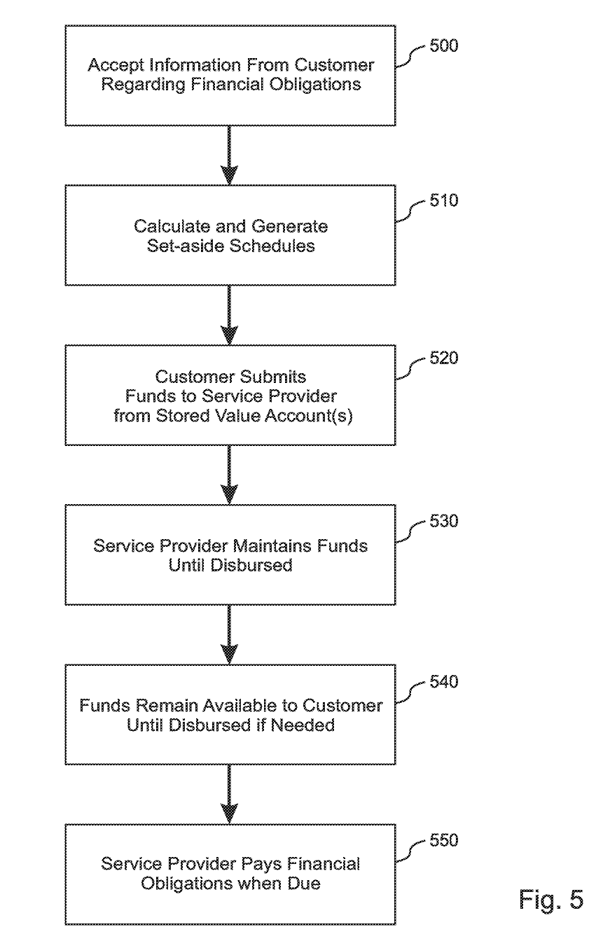

FIG. 5 is a flowchart of a method according to an embodiment of the present invention in which the funds that are set aside are provided by the customer to the third party service provider from one or more stored value accounts.

In operation 500, a third party service provider accepts financial information from a customer regarding a plurality of financial obligations. For example, a web page is displayed on the customer's computer and the customer enters financial information into a graphical user interface provided by the web page.

In operation 510, set-aside schedules including set-aside amounts are determined for each of the financial obligations.

In operation 520, the customer provides set-aside funds to the service provider from one or more stored value accounts according to the set-aside schedules. In some embodiments, each providing of funds is initiated by the customer, for example by initiating an online transaction or by appearing in person at a service provider facility. In other embodiments, the set-aside funds are transferred automatically from the customer's stored value account(s) to the service provider. For each of the plurality of financial obligations, the funds can be provided in a single set-aside, or in more than one set-aside. For example, a customer may wish to set aside funds each week for a different obligation, where each amount set aside is sufficient to meet a corresponding obligation. As a specific example, rent money may be set aside one week, food money another week, and so forth.

In operation 530, the third party service provider maintains the set-aside funds until they are disbursed. In various embodiments, the set-aside funds are maintained in one or more bank accounts, or in one or more stored value accounts. The set-aside funds remain available to the customer 540 and can be accessed in case of an unanticipated emergency, need, or opportunity.

And in operation 550, the third party service provider pays each of the financial obligations when due.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A financial management method executed by a third party service provider for reserving funds in anticipation of meeting a financial obligation of a customer without reducing, avoiding, or deferring any portion of the financial obligation, the financial obligation including a payment amount due to a creditor by a payment due date, the method comprising:
receiving financial data corresponding to the customer, the financial data including data regarding the financial obligation;
during a set-aside period leading up to the payment due date, transferring one or more amounts of money from a monetary source corresponding to the customer to a set-aside account, where the sum of the transferred amounts of money is equal to or more than the payment amount, at least one of the monetary source and the set-aside account being a stored value account; and
in a single transaction prior to or on the payment due date, using the money in the set-aside account to meet the financial obligation without reducing, avoiding, or deferring any portion of the financial obligation.

2. The method of claim 1, wherein the customer is able to withdraw money from the set-aside account before the money is used to meet the financial obligation.

3. The method of claim 1, wherein the customer is able to adjust at least one of an amount of money transferred and a timing of a transfer of money during the set-aside period.

4. The method of claim 1, wherein the set-aside account is a stored value card, and the method further includes providing the stored value card to the customer.

5. The method of claim 4, wherein the stored value card can be used by the customer in lieu of a bank card.

6. The method of claim 4, wherein amounts of money are transferred from at least one monetary source to a plurality of stored value cards in anticipation of meeting a plurality of financial obligations, and each of the stored value cards includes a visibly perceptible indication that identifies to which of the financial obligations it is directed.

7. The method of claim 1, wherein the set-aside account is a stored value account maintained by a data processing system as information in a database.

8. The method of claim 7, wherein the money transferred to the stored value account is automatically disbursed by the third party service provider to meet the financial obligation.

9. The method of claim 8, wherein the money is disbursed electronically.

10. The method of claim 1, further comprising:
monitoring during the set-aside period an amount of funds available from the monetary source; and
determining at least one of when to transfer money to the set-aside account and how much money to transfer to the set-aside account according to the amount of funds available from the monetary source.

11. The method of claim 1, wherein the creditor is a taxing authority.

12. The method of claim 11, wherein the financial obligation is an estimated tax payment.

13. The method of claim 12, further comprising determining the estimated tax due as a function of the received financial data.

14. The method of claim 1, wherein the financial obligation is a mortgage payment.

15. The method of claim 1, wherein the monetary source is at least one of a bank account, a stock portfolio account, and a trust fund.

16. The method of claim 1, wherein the monetary source is cash or a cash equivalent provided by the customer to the third party service provider

17. The method of claim 1, wherein the financial source is a source of wages for the customer.

18. The method of claim 1, further comprising borrowing money so as to provide funds for transfer to the set-aside account.

19. The method of claim 1, wherein the one or more amounts of money are transferred to the set-aside account periodically according to a set-aside schedule.

20. The method of claim 19, further comprising;
accepting from the customer set-aside preferences including a preferred set-aside period and an amount per period to be set aside; and
determining the set-aside schedule according to the set-aside preferences.

21. The method of claim 19, further comprising displaying to the customer the set-aside schedule, and enabling the customer to accept or adjust the set-aside schedule.
